(19) United States
(12) Patent Application Publication
(10) Pub. No.: US 2014/0180501 A1
(43) Pub. Date: Jun. 26, 2014

(54) CONTROL SYSTEM AND METHOD FOR AUTOMATED VEHICLE FLEET

(71) Applicant: Alexander Leopold Kyllmann, Zapopan (MX)

(72) Inventor: Alexander Leopold Kyllmann, Zapopan (MX)

(73) Assignee: MODUTRAM MEXICO, S.A. DE D.V., Zapopan, Jalisco (MX)

(21) Appl. No.: 14/234,369

(22) PCT Filed: Jul. 3, 2012
(86) PCT No.: PCT/MX2012/000064

§ 371 Date: Jan. 22, 2014

(51) Int. Cl. G05D 1/00

(52) U.S. Cl. CPC G05D 1/0027
USPC 701/2

(57) ABSTRACT

A control system and method of a fleet of automated vehicles moving through a road network, which comprises some stationery and mobile control devices, of which some are fully independent of the mechanisms and technologies implemented in the vehicles, and some media to establish communication between the control devices by using, in some media, open communion protocols and, in others, closed protocols for the control of the different variables involved in the safe efficient operation in the transport of persons, cargo or both.

### FIELD OF INVENTION

This invention is related to the automated transport sector and, more specifically, is related to an intelligent control system and method for a land transport system for persons, cargo or both, based on a fleet of driverless vehicles in an exclusive road network and with individualized service which automatically adapts to instantaneous demand.

### BACKGROUND OF THE INVENTION

### State of the Art

The concept of an individualized automated transport system has been described in different patent documents, and some of these documents also describe the specific system and method which would be used to control the operation of such transport system. For instance, patent document WO 2006/049617 (James) describes a public transport system which includes control of ultra-light transit vehicles, suspended on a single lane or on two and power operated, by means of highly distributed communications. The transport vehicles are suitable for transporting one to four persons. The system includes a number of interconnected lanes with primary lanes and station lanes to provide uninterrupted transport from one station to another.

Another intelligent transport system is described in patent document WO2003/035427 (Gaegauf), which refers to an automated transport system which includes a number of vehicles adapted to travel along a lane, and a monitoring system located inside each vehicle and adapted to control a location and a speed between an associated vehicle and the road. The automated transport system also includes a transmitter situated inside each vehicle and adapted to transmit a signal which includes data on the location and the monitored speed, and a receptor situated inside each vehicle and adapted to receive the signal from each of the other vehicles. The automated transport system also includes a controller located inside each vehicle and adapted to interpret the signal received by the receptor and to control the associated vehicle in order to provide adequate space between the remaining vehicles to prevent collisions between such vehicles and to maximize the performance of the vehicles along the route.

The most relevant characteristics of an individualized automated transport system which affect the control system are those which are listed below:

1. The road network is generally fully interconnected so that a vehicle can go from any point to another point in the network;

2. Given the nature of the individualized transport, there are usually many small vehicles on the road network instead of a few large vehicles, which means that there could be up to tens of thousands of vehicles in the case of an extensive network, and the gaps between the vehicles may end up being very short, for instance, less than three seconds between the front of one vehicle and the front of the vehicle following it;

3. Users access the transport system at stations, which are generally not located directly on the main lanes of the road network, but rather on secondary lanes so that the vehicles standing in the stations do not affect the flow of vehicles on the main lanes;

Based on the above, the intelligent control system for the transport system needs to be able to carry out the following functions:
1. Control the movement of the vehicles in response to instantaneous demand for the service by users instead of using schedules and fixed routes;
2. Drive each vehicle from the origin station directly to the destination station selected beforehand by the user with no additional involvement of the user during the journey;
3. Plan the route for each journey in order to minimize power use, optimize use of system resources and prevent congestion on the road network;
4. Automatically redirect traffic in the event of an emergency, anomaly or block on the lanes;
5. Regulate the journey speed of each vehicle as needed, for instance, slow the vehicle down on entering a station and accelerate the vehicle on leaving the station, etc.;
6. Maintain adequate gap distances and times between the vehicles and control the order in which vehicles go through the road junctions in order to prevent collisions.

While control and/or setting systems and/or control methods which carry out some or all of the functionalities mentioned have already been proposed, none of these suggest or describe how to, at any given time, resolve the interoperability of vehicles which have different propulsion, drive and/or braking technologies, or which are provided by different suppliers for a large scale road network.

The problems of controlling the movement of a group of automated vehicles in a road network is described below, specifically in relation to functionalities 5 and 6 of the above list:

In order to be able to control the movement of a group of automated vehicles (without human involvement) safely and reliably, it is necessary to determine with certain regularity the location, speed and instantaneous acceleration of each vehicle, and to adjust as required the longitudinal movements and side turns of the vehicles by means of their propulsion, drive and braking mechanisms. For an expert in the field, it will be evident that to accomplish this, different control devices with their respective sensors, actuators and software are required, as well as a certain communication between the control devices.

There are many different possible settings in terms of the amount of control devices, their location and functionality, communication media and methods between the devices and use of devices or additional absolute location reference elements (not only relative) of the vehicles. The design of a particular setting depends on the cost, safety and reliability objectives, among others, which the control system must fulfill.

The main factors which have been deemed by other previous proposals in the design of the setting of the control system are the following:

a) The degree of centralization (or decentralization) which the control system must have; and

b) The use of a synchronous, almost-synchronous or asynchronous control to regulate the advance of vehicles along the road in order to maintain an adequate gap between them and to decide which of the two vehicles can pass first at a road junction.

However, such systems have omitted other additional factors which must be considered, above all for a large scale road network, for instance:

a) Accomplishing the interoperability of the control system with vehicles from different suppliers and even with different propulsion, drive and braking technologies without affecting the safety of the transport system; and

b) Accomplishing that the automated vehicles to possess differentiated acceleration, deceleration and speed behaviors, including in the same road network sections in order to be able to optimize use of the road network at times of high demand without putting the safety of the transport at risk.

The above factors are important because, unlike a collective automated transport system with large vehicles where the number of vehicles totals only a few dozen, in an individualized automated transport system, the number of vehicles operating in a large scale road network can be as much as tens of thousands. For reasons of industrial and economic viability, it is likely that this large amount of vehicles is supplied by more than one supplier, and it is also likely that having more than one supplier means that the technological designs of the vehicles are different. Also, technological improvements shall not be easily implemented throughout the entire vehicle fleet at the same time, therefore, the control system must be able to enable vehicles from different suppliers and with different propulsion, drive and braking technologies to coexist in the same road network with no need to redesign, reconfigure or repeat all the tests on the entire control system when vehicles with different technologies are added, since this would be impractical and unaffordable.

Therefore, when you have a transport system with tens of thousands of vehicles supplied by different suppliers, it is evident that certain standardization is required in the control system so that the vehicles can coexist on the same automated road network. However, it is also extremely important for passenger safety that the control system not be susceptible to external handling (malicious), and any standardized interface represents a vulnerability that could be taken advantage of to handle the control system, especially in wireless communication.

While there are already some proposals to resolve the problem of how to accurately control the longitudinal movement of vehicles so that the vehicles follow pre-established speed and position profiles, the methods proposed up to now to control the movements of an entire fleet of vehicles is based on the fact that all the vehicles follow a few predetermined acceleration and speed profiles, or that the vehicles follow the (virtual) traffic light instructions, which allow or prohibit the advance of the vehicle throughout the road network. However, having up to tens of thousands of vehicles in the network means that in order to truly be able to optimize use of the system resources, it is necessary for the speed profiles the vehicles must follow to be calculated based on current traffic conditions and demand in the immediate future, which involves each vehicle which passes through the same section of road network being able to have a different acceleration and speed profile, provided they meet the established limits for reasons of safety and/or comfort.

As shall be described in the respective chapter, the system and method of this invention meets the requirements stipulated above.

### OBJECTS OF THE INVENTION

A main object of the invention is to propose an intelligent control system capable of controlling transport vehicles from different suppliers and even with different propulsion, drive and braking technologies without affecting the safety of the transport system.

In a preferred embodiment of achievement, the control system is characterized by comprising:

a) a group of stationary control devices (DZ, DS) installed on the roads or in central facilities, and a group of mobile control devices installed in the vehicles (DT, DM);

b) at least one control device (DT) in each vehicle, which is fully independent from the propulsion, drive and braking technologies and operation of the doors implemented in the vehicle and which can be communicated with the stationary control devices;

c) at least one control device (DM) in each vehicle, which is fully independent from the stationary control devices and which is compatible with propulsion, drive and braking technologies and operation of the doors implemented in the vehicle;

d) a communication interface based on an open standard and an open protocol between the control device(s) (DT) and the control device(s) (DM);

e) a communication interface between stationery control devices and the control device (DT) characterized by a very high degree of protection from unauthorized handling of the information which flows through it, including use of closed communication protocols.

Another object of this invention is to propose a control system or method which enables the automated vehicles to possess differentiated acceleration, deceleration and speed behaviors, even in the same road network sections, in order to be able to optimize use of the road network during times of high demand without putting the safety of the transport at risk.

In a preferred embodiment of the control method of this invention, such method is characterized in that the stages of:

a) calculating and assign an acceleration, speed and individual position profile for each vehicle which crosses any road section by means of a control device it knows, and where, in such case, it can order changes to speeds and positions of the other vehicles located on that road section, wherein such profile may vary from the profiles assigned to other vehicles in that same road section, according to some or several of the following conditions: the need for the future use of system resources; current traffic conditions in that section; gap times between that vehicle and the vehicles traveling in front and behind; and the availability of resources shared with other vehicles, particularly the junctions in that road section;

b) transmitting the profile calculated in stage (a) above to a control device in the vehicle which must execute that profile, in the form of coded instructions;

c) decoding the profile and transmitting it through the device referred to in stage (b) above to one or more control devices in the vehicle different from the device referred to in stage (b), in the form of instructions based on an open communication protocol;

d) activating propulsion, drive and braking mechanisms inside the vehicle through the devices referred to in stage (c) so that the actual acceleration, speed and position of the vehicle at any time agrees with the acceleration, speed and position profile previously calculated and assigned to the vehicle.

The above and other objects of the invention shall be made evident with the help of the detailed description, which for such purpose forms part of this text.

In order to facilitate understanding of the system, some concepts, which shall be used throughout the description of the invention, are defined below:

Installation: The entirety of the road network, stations, vehicles and control elements contained in a specific application of the transport system. Each installation is made up of one or more zones and can be built in one or more stages.

Zone: A part of an installation. In each zone, the road network is made up of one or more sections.

Section: A part of the road network of a zone, which includes at least one road junction. Each section is made up of one or more segments.

Segment: A part (a section of road) of a section. Each segment has an associated speed limit and, in such case, a specific behavior, which any vehicle found in this segment must usually follow, for instance, a certain action of the doors. There is a segment for each speed limit change or vehicle behavior change that is required along the road.

DZ: Zone control device available in each zone of the road network.

DS: Section control device available in each section of the road network.

DT: Vehicle task control device installed in each vehicle.

DM: Vehicle mechanism(s) control device(s) installed in each vehicle.

C1: Communication media or channel through which DS devices and the DZ device of a zone communicate with each other.

C2: Communication media or channel through which both DS devices and the DZ device communicate with DT devices which are inside the zone.

C3: Communication media or channel of each vehicle through which the DT device communicates with the DM device(s).

C4: Communication media or channel through which DZ devices communicate between themselves in the event of having more than one DZ device.

### BRIEF DESCRIPTION OF DRAWINGS

FIG. 1 is a schematic representation which exemplifies the conceptual design of an installation of an individualized automated transport system.

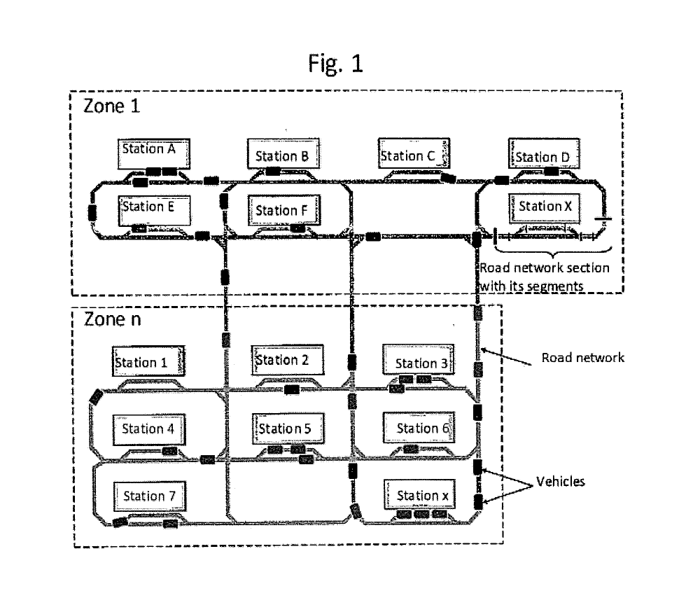

FIG. 2 is a schematic representation of the intelligent control system for the automated transport system of this invention.

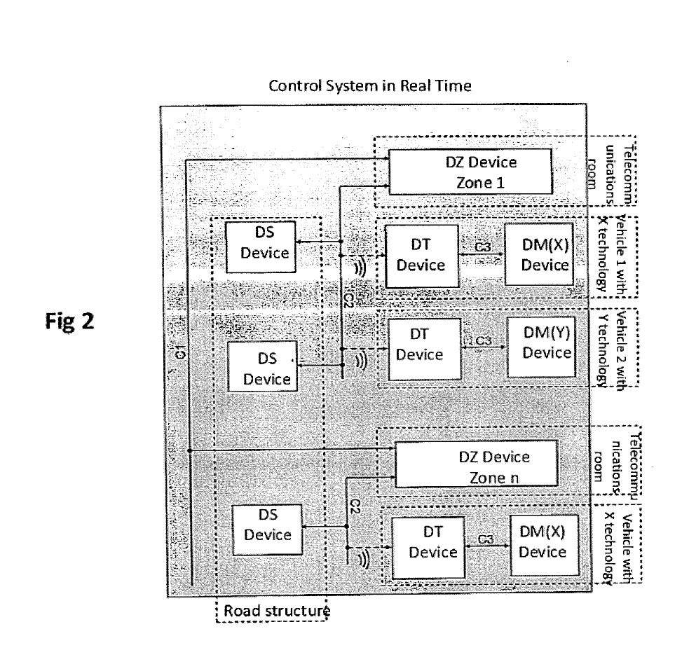

### DETAILED DESCRIPTION OF THE PREFERRED EMBODIMENT OF THE INVENTION

A control system and method which resolves certain problems not approached and not resolved by others is described. Generally, the control system has the following main control devices, each with its respective sensors, actuators and software:
1) some stationary and mobile control devices, wherein:
   a) the stationary control devices comprise:
      a1) One or more DZ control devices in each zone which basically execute high level control tasks (calculation of optimal route between origin and destination, balancing of traffic in the road network, etc.) in order to optimize the operation of the system as a whole. For this, they possess information on the entirely of the system (such as the entire surface area of the road network, the location of all the vehicles, etc.) and can share information with all the other devices; and
      a2) one or more DS control devices in each section which execute the same set of low level control tasks and which possess information on only one small part of the system (a road section, the location of the vehicles in that section, etc.) and share information only with nearby devices from adjacent sections The DS device(s) attain differentiated results according to the circumstances (for instance, different vehicle speeds according to traffic conditions) by optimizing the operation of its part of the system (for instance, the passing of vehicles through junctions) and attain results which, while still different, are predictable and therefore verifiable. Therefore, the results of the tasks executed by the DS device(s) converge to attain a greater common objective.
   b) the mobile control devices installed in the vehicles comprise:
      b1) one or more DT control devices which possess information on the stationary control devices and share information with them, as well as with other DT control devices installed in other vehicles, and also with DM mobile control devices installed in the same vehicle. The DT control device(s) acts as an interface between the vehicle and the other elements of the control system outside the vehicle. They are not familiar with the mechanisms installed in the vehicle and their input and output signals are the same regardless of the technology and/or the mechanisms implemented in the vehicle. The DT control device(s) manage to translate the instructions issued by the stationery devices and transmit them to the DM mobile control devices. Therefore, they successfully bring the vehicle to a safe state if the instructions issued by the stationery devices are not complied with and such failure to comply could be dangerous.
      b2) one or more DM mobile control devices which possess information on the technology implemented in the vehicle in which they are going to be installed, as well as the means necessary to manage it and measure the results, and which share information with the DT devices installed in the same vehicle. Therefore, they are not familiar with the other elements of the control system outside the vehicle; they achieve to convert the instructions and/or signals issued by DT mobile devices into physical behaviors of the vehicle or its components; they achieve to detect and/or measure the actual behavior of the vehicle or its components and accomplish to bring the vehicle to a safe state if the actual behavior does not correspond to the required behavior and this represents a danger.
2) some communication media (C1, C2, C3) which, due to the nature of the system, incorporate means or mechanisms suitable for attaining security of the information which flows between the different system components, where such communication media have the following functionalities:

between stationery DZ devices and stationery DZ or DS devices, the C1 communication media carry information which is not critical for passenger safety. In this case, they can include wired or wireless communication channels;

between nearby stationery DS devices, the C1 communication media carry information which may be critical for passenger safety. They typically include only wired communication channels, though they can include wireless communication channels properly protected from third party access;

between stationery DZ or DS devices and mobile DT devices, as well as between nearby mobile DT devices, the C1 communication media carry information which may be critical for passenger safety. They typically include communication channels which can be easier for third parties to access. Therefore, a communication interface based on non-public specifications is proposed, which can include the use of closed protocols and data and/or electronic signature encryption to attain the required security of the information;

between mobile DT devices and mobile DM devices, the C2 communication media carry information which may be critical for passenger safety. They typically include only wired communication channels, protected from third party access. The communication interface is based on open standards and protocols;

between stationery DZ or DS devices and mobile DM devices, direct communication is not possible between them without passing through another type of device in order to create additional communication channels (C3).

In the case of very big systems, the system can be “split” with each part (zone) acting as an individual system but interconnected with nearby parts (zones).

Important characteristics and functionalities of the system devices:
1) The DZ control device carries out the following three main functions:
   Firstly, it continuously programs the subsequent journeys of the vehicles which are in its zone and communicates the journey plan of each vehicle to the DT device installed in that vehicle. Journeys can be for transporting persons or cargo from one station to another, as requested by users (including journeys to other zones), in order to relocate empty vehicles in the road network (to attend to planned demand in the future) or send vehicles to maintenance or for recharging.
   Secondly, it supervises vehicle traffic inside its zone, for which it constantly receives information on the current locations of all vehicles from DS devices inside its zone, and provides the DS devices with instructions enabling them to optimize traffic flow throughout the zone.
   Lastly, it receives information on alerts and faults reported by DS and DT devices and, in the case of an anomaly in the system, for instance, a vehicle that is off the road, it redirects the traffic by sending respective instructions to the DS and DT devices.
2) The DS control device carries out the following three main functions: it regulates vehicle speed, manages vehicle right-of-way at junctions and maintains minimum predefined gaps between vehicles. In order to accomplish this, it carries out the following tasks:
   It records the entry of any vehicle into its control section by means of sensors installed in the lane at the start of the section, and assumes responsibility for vehicle control from this moment until the vehicle passes into the next control section;
   It calculates for each vehicle which enters its control section the specific speed profile, which must be followed by that vehicle in that section, and communicates it to the DT installed in that vehicle. The calculated profile take into account both permanent factors, for instance, bends in the roads at which vehicles must reduce their speed and situational factors, for instance, the actual gap that exists—and the one that must exist—between the vehicle in question and the vehicle traveling immediately in front in that section;
   It monitors the advance of the vehicle inside the section by comparing the actual advance with the programmed advance;
   It records the passing of vehicles through the fork in the road and/or junction of its section in order to be certain of the route taken by the vehicle; and
It communicates the advance of all vehicles in its section to the DZ device and to the DS devices of adjacent sections.
3) The DT control device is completely independent from the propulsion, drive and braking mechanisms and technologies and operation of the vehicle doors. Their function is to act has an interface between the vehicle and the external environment of the vehicle. It exchanges information with the DZ device of the zone in which it the vehicle is located, the DS devices of the road sections through which the vehicle is passing and other DT devices installed in the vehicles traveling in front of and behind the vehicle itself. In addition, by means of sensors connected to the DT device, such device records the absolute location of the vehicle at certain points along the road. On the basis of this information, the DT device gives instructions to the DM device on how the vehicle must behave at any time.

The specific activities executed by the DT device include the following:
Firstly, it receives and processes instructions from the DZ device with a new “mission” (journey plan) for the vehicle. The mission include the destination and the route which the vehicle must follow to get to the destination, expressed as the list of sections through which the vehicle shall pass and the lane which the vehicle must take at each fork in the road (left or right).
Secondly, it receives instructions from the DS device with a coded description of the speed and movement profile, which must be followed by the vehicle in the road section in which the vehicle is located.
Thirdly, it reconstructs the speed and movement profile calculated by the DS device and transmits it to the DM device during the course of the journey through the section.
Fourthly, it transmits to the DM device instructions to execute maneuvers as needed, such as moving the directional mechanism to the left or right, opening or closing the doors, etc.
4) The DM control device controls the propulsion, drive and braking mechanisms and operation of the vehicle doors (among others). Therefore, its design is specific for a vehicle model and is fully independent of the operation of all the other elements of the control system, which are outside the vehicle. It only communicates with the DT device through the communication channel between those two (C3 medium). Its main function is to make the vehicle follow the behavior requested of it by the DT device; it also monitors the state of the propulsion, drive, etc. components, and within the limits imposed by the DT device it can optimize certain performance parameters according to the objectives of the vehicle manufacturer (power consumption, passenger comfort, etc.). There are different sensors and actuators connected to the DM device, such as speed sensors on the wheels, position sensors on the directional mechanism, actuators to move the directional mechanism, actuators to accelerate the motor(s), actuators to apply or remove the brake, etc.
5) The communication media are independent of the technology used. The C2 medium, by means of which stationery (DZ, DS) devices communicate with mobile (DT) devices, is characterized by enabling communication at any time regardless of the location of the vehicle throughout the road network. This is typically done with wireless digital communication technology. However, in order to complicate unauthorized access to the telecommunication network, the C2 medium is characterized by requiring physical proximity so that any device can access it (gap of less than 10 feet), as well as through the use of a “closed” communication protocol. For its part, the C3 medium is characterized by requiring a physical connection so that a device can access it, but it is based on an open communication standard and protocol.

The interoperability (coexistence) of several vehicular technologies in the same installation, the correct and safe operation of the entire automated transport system notwithstanding, is obtained through the physical architecture of the control system already described. In this architecture, the interface between the part of the control system which is dependent on the propulsion, drive and braking technologies and physical mechanisms and operation of doors implemented in the vehicle and the part of the control system which is completely independent of such mechanisms, is located in the vehicle instead of being located on the limit between the vehicle and the external environment. This location of the interface inside the vehicle enables the vehicle design and the validation of its compatibility with the automated control system to be done without any interaction with the elements of the control system which are outside the vehicle. This facilitates and speeds up the development of new vehicle models to be incorporated into the fleet and also speeds up validation of the operation of new models in the automated system, since it is certain that once the functionality of the isolated vehicle is validated, the functionality of the entire system (vehicle integrated within the rest of the system) cannot have been negatively affected due to the simple fact that it has not changed anything at all in the interface between the vehicle and the system outside the vehicle.

As for safe operation, if the interface between the part of the control system which is dependent on the propulsion, drive and braking technologies and physical mechanisms and operation of doors implemented in the vehicle and the part of the control system which is fully independent of such mechanisms is inside the vehicle (instead of being located on the limit between the vehicle and the external environment), so such interface can be openly specified, for instance, by means of a standard, and the likelihood that the signals and information which flow through such interface are being handled with malicious intent are still extremely low, since inside the vehicle is it very viable to protect the signals and information which flows through C3 communication medium and to complicate improper access thereto. If the interface were located on the limit between the vehicle and external environment, the specification of such interface would include the specification of the communication protocol used in C2 communication medium, which by being wireless is more inclined to enable unauthorized access and therefore involves a higher likelihood that the signals and information which flows through such interface are handled with malicious intent.

Differentiated optimized behavior of automated vehicles, including in the same road network sections, is attained by means of the methodology described to control the acceleration, speed and position of each vehicle. In this methodology, a stationery device which is responsible for the movement of all the vehicles inside its control area, (in this case it is the DS device which is responsible of the movement of vehicles in its section) calculates an acceleration, speed and position profile for each vehicle which enters its control area and this profile can be different to the calculated profile for the previous vehicle and for the next vehicle, depending on the situation. Specifically, the profile calculated for a vehicle determines its acceleration, speed and position at any time during the period in which the vehicle remains in this section and is a function of several entry parameters and variables, including:
a. the length of each of the segments of the section through which the vehicle shall pass until it leaves the section (values given by the physical route of the road and by the particular route the vehicle takes);
b. the maximum permitted speed in each of those road segments (predefined fixed values for safety reasons);
c. the cruising speed (parameter given by the DZ device);
d. the speed at which the vehicle entered the section (which can vary according to the circumstances);
e. the gap that exists between the current and preceding vehicle, as well as the acceleration, speed and position profile assigned to this preceding vehicle;
f. the time in which other vehicles shall go through a junction through which the current vehicle must pass; and
g. the priority which the vehicles must have in going through the junction, which can be a combination of fixed rules and parameters given by the DZ.

In this way, it becomes possible to constantly adjust the gaps between vehicles, whether to maximize the flow of vehicles when necessary (at times of high service demand) or to minimize power consumption whenever necessary, or to accomplish any other object the transport system operator wishes.

This differentiated optimized behavior of automated vehicles is not at the expense of safety, since the behavior of each vehicle is defined in advance (in other words, before being executed) by a device which is familiar with the behavior of the other vehicles which are located in the vicinity, thereby preventing the potential danger of vehicles getting too close to each other. Furthermore, once the profile for a vehicle is defined and communicated to its DT device, in the event that the actual acceleration, speed or position measured by the DT (or any other device in the vehicle) does not agree with the profile ordered by the DS device, the DT (or any other device in the vehicle) can begin the necessary actions to return to a safe state like, for instance, activating the emergency brake.

In a preferred embodiment of the control method of this invention, such method is characterized by understanding the stages of:
a) calculating and assigning a route to a vehicle for a journey based on knowledge of the road network and its the current and future traffic distribution, in which this stage can be executed out again once the vehicle's journey has begun from its current location to its destination if unforeseen anomalies or congestion appear in the road network or in the stations and it is executed by one or several stationery DZ control devices;
b) calculating a speed profile and sequence of behaviors of the vehicles throughout their time inside a road section based on knowledge of the current and future locations and speeds of other vehicles inside that same section, in which this stage is executed out by one or several stationery DS control devices at the moment the vehicle enters the section, therefore, this stage can:
   execute in parallel many responses and can give different results each time it is executed out under different circumstances, but always giving a predictable result and always reaching a solution which achieves the objective(s) put forward; and
   repeat for the same vehicle at any time after the vehicle has already entered the section if current traffic conditions inside such section no longer correspond to the conditions foreseen when the original profile was calculated;
c) transmitting the profile calculated in stage (b) above to the vehicle which must execute it, in which this stage can be carried out in two sub-stages, the first being outside (or towards) the vehicle using a means not necessarily standardized and/or a protocol which is not of public knowledge, and the second being inside the same vehicle using a standardized means and an open protocol. The profile is transmitted between stationery DS devices and mobile DT devices and DM mobile devices;
d) converting the calculated profile and instructions into physical behaviors of the vehicle and its components based on knowledge of the technologies and/or mechanisms implemented in the vehicle. This stage is executed after the previous stage and during the vehicle's journey through the section. Therefore, such conversion can be executed by one or several different DM devices, each one corresponding to one or more mechanisms inside the vehicle; and
e) comparing the requested behavior with the actual behavior of the vehicle, an action which is continuously executed during the journey of the vehicle through the section with the objective of applying the appropriate measures (for instance, applying the emergency brake) in the event that dangerous situations arise, and in which such comparison is made by any or several of the mobile DT or DM control devices, and/or stationery DZ or DS devices.

Stages b) and e) above are repeated until the journey calculated for this vehicle is completed.

It is worth noting that the method described above can also be applied in the event that the vehicle is a sole individual vehicle or a convoy or vehicles, which travel together forming a vehicular unit with the same route and same profile and eventually such convoy is dynamically integrated or un-integrated, as needed. In other words, the journeys of individual vehicles with routes which share the same sections at the same times are converted into a single journey of a temporary convoy until the individual vehicles retake their own journeys to get to their respective destinations.

Though the invention has been described in the context of the preferred embodiment or form of execution, it shall be evident to specialists in the field that the scope of the exemplifying concept extends beyond the architecture of the system and method specifically described and illustrated to other possible alternative materialization embodiments of the invention which are feasible or viable. Furthermore, while the invention has been described in detail, any expert in the field to which the invention belongs shall be able to deduce that some constitutive elements of the system and/or stages of the method can be replaced or other different ones can be incorporated in light of the above description, without it essentially amending the result for which it has been conceived.

Due to the above, the intention is that the scope of this invention is not interpreted as limited by the particular embodiment described, but rather that it is determined by a reasonable interpretation of the content of the following claims.

1. A control system of a fleet of automated vehicles moving through a road network in which some stationery control devices are installed, which shall interact with some control devices installed in the vehicles, which comprises the following main control devices, each one with its respective sensors, actuators and software:
1) some stationary and mobile control devices, wherein:
a) the stationery control devices comprising:
a1) one or more DZ control devices in each zone which basically execute control tasks in order to optimize the operation of the entire system. For this they possess information on the entire the system and can share information with all the other devices; and
a2) one or more DS control devices in each section which possess information on only one small part of the system and share information only with nearby devices from adjacent sections, and which execute the same set of control tasks in order to regulate traffic in their section;
b) the mobile control devices installed in the vehicles comprise:
b1) one or more DT control devices which possess information on the stationery control devices and share information with them, as well as with other DT control devices installed in other vehicles, and also with DM mobile control devices installed in the same vehicle. The DT control device(s) act as an interface between the vehicle and the other elements of the control system outside the vehicle, are not familiar with the mechanisms installed in the vehicle and their entry and exit signals are the same regardless of the technology and/or the mechanisms implemented in the vehicle;
b2) one or more DM mobile control devices which possess information on the technology implemented in the vehicle wherein which they are installed, as well as the means necessary to manage it and measure the results, and which share information with the DT devices installed in the same vehicle. Therefore, the DM devices are not familiar with the other elements of the control system outside the vehicle and convert the instructions and/or signals issued by the DT mobile devices into physical behaviors of the vehicle or its components;
2) some communication media (C1, C2, C3) which incorporate means or mechanisms to guarantee the security of the information which flows between the control devices (DZ, DS, DT, DM) of the system, wherein C1 communication media intercommunicate to the stationery devices (DZ and DS) between them, the C2 media intercommunicate to the stationery devices with the DT mobile devices, and the C3 media intercommunicate to the DT devices with the DM devices inside a vehicle.

2. The system of claim 1, wherein the DT control device or devices translate the instructions issued by the stationery devices and they transmit them to the mobile DM control devices in order to activate the vehicle mechanisms.

3. The system of claim 1, wherein the C2 communication media, which carry information that may be critical for passenger safety, use a communication interface based on non-public specifications which may include the use of closed protocols and data and/or electronic signature encryption in order to attain the information security required.

4. The system of claim 1, wherein the C3 communication media, which carry information that may be critical for passenger safety, only includes wired communication channels protected from third party access and the communication interface is based on open standards and protocols.

5. The system of claim 1, wherein the DS devices accomplish differentiated results according to traffic circumstances in the road network which, while still being different, are predictable and therefore verifiable for the optimal operation of their part of the system;

6. The system of claim 1, wherein the DT control devices bring the vehicle to a safe state if the instructions issued by the stationery devices are not complied with and such failure to comply could be dangerous.

7. The system of claim 1, wherein the DM devices detect and/or measure the actual behavior of the vehicle and its components and being the vehicle to a safe state if the actual behavior does not correspond to the required behavior and this represents a danger.

8. The system of claim 1, wherein the control devices (DT) are fully independent of any propulsion, drive or braking technology and mechanism and operation of the doors implemented in any of the vehicles, with which vehicles with different technologies can be introduced and coexist simultaneously in a road network without affecting the operation of the automated transport control system.

9. The system of claim 1, wherein the control devices (DZ) are charged with continuously programming the subsequent journey of the vehicles which are inside the zone and supervising vehicle traffic in their zone, for which it interacts with other control devices from their zone in order to optimize traffic flow throughout the entire zone.

10. The system of claim 1, wherein the control devices (DZ) also redirect traffic in their zone if the control devices (DS) and the control device (DT) report anomalies in the system.

11. The system of claim 1, wherein the control device (DS) is charged with the differentiated behavior of the vehicles by calculating the acceleration, speed and position profile for each vehicle which enters its control area, and this profile can be different from the profile calculated for the previous vehicle and for the next vehicle, depending on the situation.

12. The system of claim 1, wherein the control devices (DS) regulate the vehicle speed, manage vehicle right-of-way at junctions and maintain minimal predefined gaps between vehicles.

13. A control method of a fleet of automated vehicles moving through a road network, wherein some stationery control devices are installed which shall interact with some control devices installed in the vehicle. Such method is characterized by comprising the stages of:
a) calculating and assigning a route to a vehicle for a journey based on knowledge of the road network and current and future traffic distribution;
b) calculating a speed profile and sequence of behaviors of the vehicle during the time spent inside a road section based on knowledge of current and future locations and speeds of other vehicles inside that same section;
c) transmitting the profile calculated in the above stage to the vehicle which must execute it;
d) converting the calculated profile and instructions into physical behaviors of the vehicle or its components based on knowledge of the technologies and/or mechanisms implemented in the vehicle;
e) continuously comparing the requested behavior with the actual behavior of the vehicle during the vehicle's journey through the section, with the aim of applying the appropriate measures in the event of dangerous situations appearing; and
wherein stages b) and e) are repeated until the journey is complete.

14. The method of claim 13, wherein the calculation and assignation stage (a) is executed periodically once the vehicle's journey has begun from its current location to its destination if unforeseen anomalies or congestion appear in the road network or at the stations.

15. The method of claim 13, wherein the calculation and assignation stage (a) is executed by one or several stationery DZ devices.

16. The method of claim 13, wherein the speed profile calculation stage (b) can be executed in parallel in many responses and can give different results each time it is executed under different circumstances, but always giving a predictable result and always reaching a solution which attains the objective(s) put forward.

17. The method of claim 13, wherein the speed profile calculation stage b) can be repeated for the same vehicle any time after the vehicle has already entered the section if the current traffic conditions inside such section no longer correspond to the conditions foreseen when the original profile was calculated.

18. The method of claim 13, wherein the calculation of the speed profile and sequence of behaviors of the vehicle during its time inside the road section is executed by one or several stationery DS devices.

19. The method of claim 13, wherein the calculated profile can be transmitted in two sub-stages: the first outside (or towards) the vehicle using a means not necessary standardized and/or a protocol which is not of public knowledge; and the second inside the vehicle itself using a standardized means and an open protocol.

20. The method of claim 13, wherein the profile is transmitted between stationery DS devices and mobile DT devices and mobile DM devices.

21. The method of claim 13, wherein the conversion of the profile and the instructions can be executed by one or several different DM devices, each one corresponding to one or more mechanisms inside the vehicle.

22. The method of claim 13, wherein the comparison stage enables the application of appropriate measures in the event of a dangerous situation.

23. The method of claim 13, wherein such comparison is made by some or several of the mobile DT or DM control devices and/or the stationery DZ or DS devices.

24. The method of claim 13, wherein it can be applied in the event that the vehicle is a sole individual vehicle or a convoy of vehicles, which travel together forming a vehicular unit with the same route and the same profile and eventually such convoy is dynamically integrated or un-integrated, as needed.

25. The method of claim 13, wherein the journeys of individual vehicles with routes which share the same sections at the same time become a single journey of a temporary convoy until the individual vehicles retake their own journeys in order to get to their respective destination.
